(19) United States
(12) Patent Application Publication
(10) Pub. No.: US 2012/0198330 A1
(43) Pub. Date: Aug. 2, 2012

(54) Electronic Book Systems and Methods

(76) Inventors: Josh Koppel, New York, NY (US); John Lema, Richmond Hill, NY (US)

(21) Appl. No.: 13/145,649

(22) PCT Filed: Dec. 8, 2009
(86) PCT No.: PCT/US09/67231

§ 371 Date: Apr. 19, 2012

Related U.S. Application Data
(60) Provisional application No. 61/120,834, filed on Dec. 8, 2008.

(51) Int. Cl. G06F 17/20

(52) U.S. Cl. 715/251

(57) ABSTRACT

The invention relates to systems and methods for providing electronic books. According to one embodiment, the invention provides an electronic book file converter system. The file converter system has an input for receiving an electronic book file in a first format. The first format file includes a text portion representing text of a printed book version. A page transition detector detects page transitions in the printed book version. A page transition marker inserts a page transition indicator in the first format file at each detected on. In that manner the converter system converts the first format file to a second format file. The page transition indicators in the second format file enable an electronic book reading device to paginate an electronic book in accordance with page numbers of the printed book version.

### CROSS REFERENCE TO RELATED APPLICATIONS

This application claims priority to U.S. provisional application Ser. No. 61/120,834 entitled Digital Book Reader, filed in the USPTO on Dec. 8, 2008 and incorporated herein by reference in its entirety.

### FIELD OF THE INVENTION

The present invention relates to electronic books and more particularly, the correlation between the page numbers in a print book and the page number in a digital version of the print book.

### BACKGROUND OF THE INVENTION

An electronic book (hereafter ebook) is an electronic version of a traditional print book. More generally, the term ‘ebook’ refers to any type of document that can be stored or distributed in an electronic manner.

An ebook can be read using an electronic book reader (e-book reader). An ebook reader is generally a digital appliance configured for receiving and processing an ebook and displaying the contents of the ebook to a viewer on a presentation device. E-book readers have been implemented on a variety of digital appliances, including desktop and laptop computers, personal digital assistants (PDA's), palmtop computers, hand-held computers, set-top boxes, dedicated reading devices, and even cellular telephones. One example of a cellular telephone configurable to implement an ebook reader is the Apple™ Iphone™

An ebook application is a software program executed on a digital device to render the ebook on a presentation means. Examples of conventional ebook applications include Microsoft Reader (www.microsoft.com/reader/default.asp) and Adobe ebook reader (www.adobe.com/products/ebookreader/main.html). An ebook application user interface typically comprises an application window divided into a text area and a functional area. The text area presents the content of the book, and the functional area provides control over the presentation such as buttons for next and previous page.

Sizes of ebook reader display devices vary widely. For that reason, ebooks are presented on a digital appliance differently than in print. For example, a print page comprising 35 lines of text, each line containing 12-15 words displays approximately 500 words. The contents of such a print page may not fit in well on a display of a hand held device having a screen size smaller than that of a typical printed book. For that reason pages in ebooks are typically ‘reflowed’ before presentation on an electronic display device. ‘Reflowing’ a page refers to displaying an amount of information based on screen size, application window size, and font size of a display device. For the example print page described above, a re-flowed page may display only 300 words, or 27 lines of 10-12 words. In that case, a 100 page print book becomes a 170 page ebook.

One consequence of reflowing is that page numbers of the original print version and page numbers of the digital version may not match. For example, when a user is in the middle of reading an eBook and decides to change the font type, font size, margins, or some other display condition. In that case, the user probably knows what page he or she was reading prior to the change in display condition. However, after the change, the content the user was previously reading will likely be found on a different page of the eBook, and the user may not be able to easily locate the place where he or she left off.

This consequence is a drawback, particularly when reading or studying using both a print version and a digital version of a book. It would be desirable for page numbers for a digital version of a printed book to match the printed page numbers.

There is a need for electronic book readers capable of providing page indications on an ebook display, wherein the page indications correspond to the pages of the printed book version.

### SUMMARY OF THE INVENTION

The invention provides systems and methods for providing electronic books to readers and to systems and methods for reading electronic books using an electronic book reading device. According to one embodiment, the invention provides an electronic book file converter system. The file converter system has an input for receiving an electronic book file in a first format. The first format file includes a text portion representing text of a printed book version. A page transition detector detects page transitions in the printed book version.

A page transition marker inserts a page transition indicator in the first format file at each detected page transition. In that manner the converter system converts the first format file to a second format file. The page transition indicators in the second format file enable an electronic book reading device to paginate an electronic book in accordance with page numbers of the printed book version.

### DESCRIPTION OF THE DRAWING FIGURES

These and other objects, features and advantages of the invention will be apparent from a consideration of the following detailed description of the invention considered in conjunction with the drawing figures, in which:

FIG. 1 is a block diagram illustrating an ebook pagination system implemented according to an embodiment of the invention;

FIG. 2 is a flowchart illustrating an ebook pagination method according to an embodiment of the invention;

FIG. 3A is a pictorial diagram of a printed book;

FIG. 3B is a pictorial diagram of a communication device suitable for implementing embodiments of the invention;

FIG. 3C illustrates the relationship of a page buffer and a viewport for rendering an ebook on the device illustrated in FIG. 3B, wherein the page buffer comprises a page of the book illustrated in FIG. 3A;

FIG. 4A-4C illustrate a relationship of a page buffer, a first viewport and a second viewport displaying portions of a same page of a book according to an embodiment of the invention;

FIG. 5A-5C illustrate a relationship of a page buffer, a first viewport and a second viewport displaying different pages of a same book according to an embodiment of the invention;

FIGS. 6A-6C illustrate steps of methods for providing a paginated book file according to embodiments of the invention;

FIG. 7 is a flowchart illustrating steps of a method for providing an electronic book according to an embodiment of the invention.

### DETAILED DESCRIPTION OF THE INVENTION

In general, electronic books are documents formatted to be paginated in accordance with the characteristics of the display device on which the ebook content will be displayed. EBooks may be displayed and read on a variety of different display devices, such as computer monitors, portable digital assistants (PDAs), pocket personal computers (PCs), and specialized eBook reader devices, for example. The screen size of the various display options may vary greatly from one display device to another.

For example, a computer monitor may have a screen size of twenty-one inches (measured diagonally) or more, while a pocket PC may have a screen size as small as a few inches. Simply by virtue of the larger screen size, more content can be displayed on the computer monitor at one time than on the pocket PC. Thus, content that appears on a certain page (e.g., page 10) of an eBook when displayed on a computer monitor may appear on a much later page (i.e., page 50) when displayed on a pocket PC or some other display device having a smaller screen size.

Font type also affects how much textual content can displayed on a display screen. Different fonts may have a different number of characters per inch and may have uniform or variable character widths. Perhaps more significantly, the size of the font also affects the amount of content displayed on a display screen. Generally, the smaller the font size, the more text that will fit on the display screen, and vice versa.

These and other display conditions (e.g., screen resolution, margins, line spacing, etc.) affect the amount of content that can be displayed on a given display screen. Accordingly, it may be difficult or impossible for a user reading an eBook on one display device to meaningfully communicate a page cite to a reader of the same eBook on another display device, because one or more of the foregoing display conditions may be different. For example, when a reader cites a meaningful quotation on page 27, line 3, this citation is likely to not be accurate for most other readers.

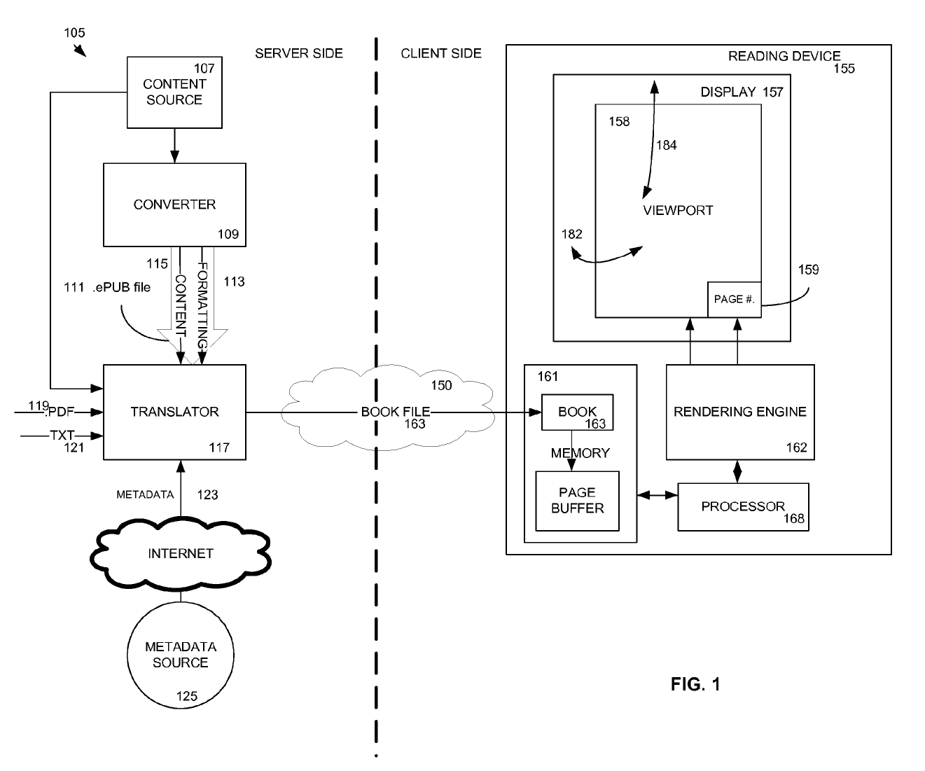

### FIGS. 1 & 2 Server System and Method

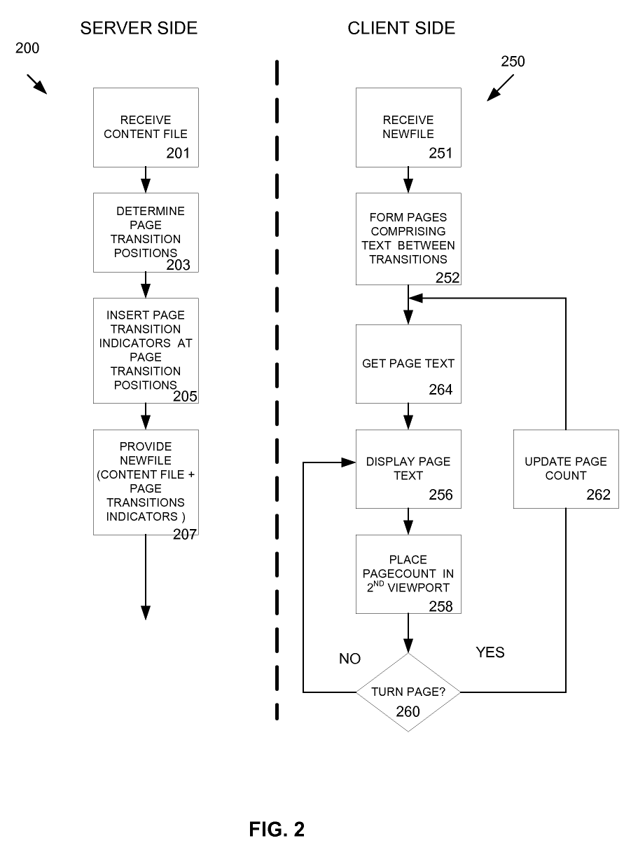

FIG. 1 illustrates an ebook generating system 105 according to an embodiment of the invention, and an ebook reading device 155 according to an embodiment of the invention. FIG. 2 illustrates a method 200 for providing an ebook and a method 250 for displaying an ebook to a viewer.

### FIG. 2 Method

FIG. 2 illustrates a method for providing an electronic book file and a method for displaying the contents of an electronic book to a viewer. In one embodiment of the invention, a method for providing an electronic book file is carried out by a server system such as that illustrated in FIG. 1 at 105. In one embodiment of the invention, a method for displaying the contents of an electronic book to a viewer are carried out on a hand held book reading device such as that illustrated in FIG. 1 at 155.

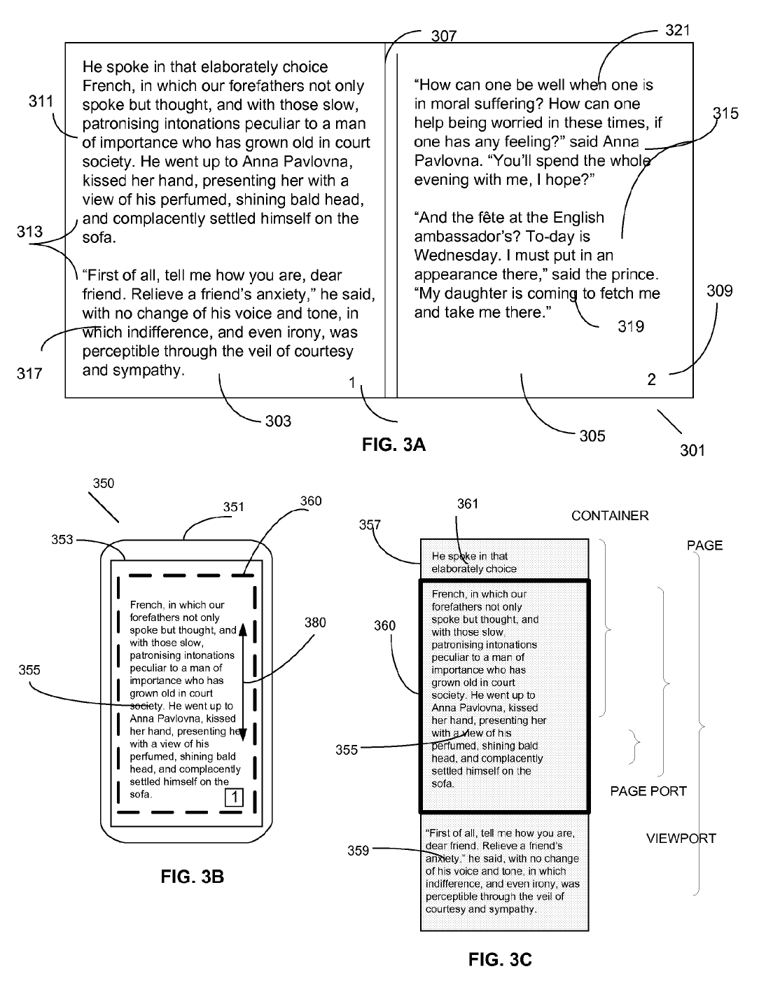

A server receives a content file comprising data representing contents of a printed book at 201. A server receives a content file comprising data representing contents of a printed book at 201. A pictorial diagram of an example printed book is illustrated in FIG. 3A. FIG. 3A represents a conventional size printed book comprising a number (n) of pages (pages 1 and 2 illustrated) coupled by a binding 307. In the example, page 1 (303) comprises printed text comprising words organized as paragraphs 313. In the example, page 1 comprises a first paragraph 311 and a second paragraph 317.

The electronic content file corresponding to a printed book includes an electronic representation of the text comprising each page of the book. However, the electronic content file does not include page information from the printed book. Therefore it is not possible to determine which portions of the electronic content file correspond to contents of a page of a printed book. Absent such information, an electronic book reader cannot indicate correspondence between displayed text and the page number of the printed book on which the displayed text can be found.

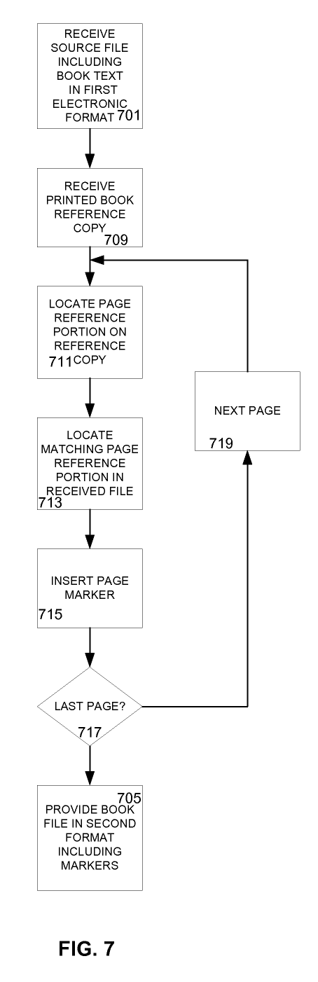

Page transitions are determined by a method of the invention at 203. In one embodiment of the invention, page transitions are determined by visual inspection of pages of a printed version of the book corresponding to the content file, as illustrated in FIG. 7. For example, a content file including text of a book is received at 701. A printed version of the same book is received at 709. A starting page of the printed version is inspected to determine a page reference portion, for example, the text of the last printed line of the starting page, as indicated at 711. At 713, the electronic file is searched to find a string of text matching the reference portion, in the example given, the last printed line of the starting page.

At 715 a page transition marker is inserted in the electronic file at a position immediately following the last word in the string of text matching the reference portion. Step 715 is also illustrated in FIG. 2 at 205. According to one embodiment of the invention a page transition marker comprises a soft break indicator. In another embodiment of the invention, a page transition marker comprises a hard break indicator. Other embodiments of the invention employ both hard and soft breaks as page transition markers. Still other embodiments of the invention employ other indicators as page transition indicators. Suitable indicators include conventional truncators and markers employed by conventional word processing applications.

The method 700 is repeated for each page of the printed book. After the final printed page has been processed, the electronic file will have a second format. The second format will differ from the format of the received content file in that the second format includes page transition markers. The page transition markers define text portions of the electronic file that correspond to full pages of the printed book. Therefore, regardless of the amount of text rendered on a book reader using the electronic file, the exact page of the printed book to which a rendered page corresponds, can be determined and displayed to a viewer.

At 7-5 (also illustrated in FIG. 2 at 207) the electronic file in the second format (indicated in FIG. 2 as ‘newfile’) is provided for eventual display on a book reading device such as that illustrated in FIG. 1 at 155.

Returning now to FIG. 2, a method 250 for displaying the contents of an electronic book to a viewer is illustrated. At 251 an electronic file in the second format described above is received. In one embodiment of the invention, the file is received via the Internet by a hand held book reading device such as that illustrated in FIG. 1 at 155. In one embodiment of the invention, the file is received from a server 105 in response to a request for a book file from a device 155.

Device 155 stores the received file in a memory (best illustrated in FIG. 1 at 163). At 252, device 155 processes the received file in accordance with the page transition markers to define portions of the received file comprising pages. The pages thus defined correspond in text content to the pages of the printed version of the book. In accordance with one embodiment of the invention, at 264, a page of text is loaded into a page buffer (best illustrated in FIG. 1 at 165) in response to a user request to view the book using electronic device 155. At least a portion of the text is displayed to the viewer on a display of device 155. According to one embodiment of the invention, a page number is determined based on the page transition indicators in the stored electronic file. At 258, a page number is displayed to a viewer on a portion of the display (for example, portion 159 of device 155 of FIG. 1).

Various portions of the page stored in page buffer 165 may be displayed on display 157 in accordance with user commands, e.g., a scroll command. However, in one embodiment of the invention, the page buffer retains the same page in the page buffer until the device receives an indication from a viewer to ‘turn page’. This is indicated in FIG. 2 at 260. In response to receiving an indication to turn a page, a page counter is updated (at 262) and a different page from the electronic file stored at 163 is loaded into page buffer 165. The process repeats until no further turn page requests are received from a viewer.

### FIG. 1 System

### Content Source 107

Content source 107 is a source of content for an electronic book. Examples of sources include electronic files provided by content creators such as authors, and content managers such as publishers. To support authors and facilitate the creation of content in a form suitable for electronic publishing a variety of tools are commercially available. In particular, tools for providing content in an XML format include dedicated XML editors (e.g., Epic by Arbortext and XMetal by SoftQuad) and extensions to Microsoft Word that allow content to be exported to XML (WorX by HyperVision and S4/Text by i4i). Other electronic file formats suitable for providing content include text files, pdf files to name but a few.

### Converter 109

In one embodiment of the invention a converter 109 receives the content from content source 107. In one embodiment of the invention, converter 109 converts the received content to a standards compliant epublishing format, for example, to an .epub format.

In other embodiments of the invention, converter 109 receives content XML content adhering to a given standard, DTD, i.e., a specified vocabulary defining the end product. For example, in one embodiment of the invention converter 109 receives an XML file with semantic mark ups corresponding to a definition, vocabulary or standard. The standard (semantic markup) is flexible enough to represent all common features (e.g. headings, sections, sub-sections, paragraphs, links) and advanced features (e.g. tables, figures and bibliography) of a publication. One example of a suitable standard is DocBook XML, used to markup documents such as books, articles, and technical documentation in logical sections.

Converter 109 converts the received content from, e.g., XML, to an ebook format. An Open eBook standard is one example of an ebook format. Another more recent standard file format suitable for use with various embodiments of the invention is an EPUB (electronic publication) (also sometimes ePub, EPub, or epub) format. The epub format is a free and open e-book standard, by the International Digital Publishing Forum (IDPF). Epub files have the extension .epub. EPUB is designed for “reflowable” content, meaning that the text display can be optimized for the particular display device. The format is meant to function as a single format that publishers and conversion houses can use in-house, as well as for distribution and sale.

Table 1 lists the contents of a .epub file.

TABLE 1

| File | Purpose |
|---|---|
| mimetype | tells a reader/operating system what's in here |
| META-INF | This folder contains, at minimum, the |
| | container.xml file, which tells the reader |
| | software where in the container to find the book. |
| OEBPS | Recommended location for the books content. |
| | It contains: |
| | images folder - images go here |
| | Content.opf - XML file that lists what's in the container |
| | toc.ncx - This is the table of Contents |
| | xhtml files - The book's contents are in these |

An example of an XHTML files for an EPUB is as follows:

```
  <?xml version=“1.0” encoding=“UTF-8” ?>
<!DOCTYPE html PUBLIC “-//W3C//DTD XHTML 1.1//EN”
“http://www.w3.org/TR/xhtml11/DTD/xhtml11.dtd”>
<html xmlns=“http://www.w3.org/1999/xhtml” xml:lang=“en”>
    <head>
      <meta http-equiv=“Content-Type” content=“application/
xhtml+xml; charset=utf-8” />
      <title>Pride and Prejudice</title>
      <link rel=“stylesheet” href=“css/main.css” type=“text/css” />
    </head>
    <body>
      ...
    </body>
</html>
```

### Reader/Paginator 117

Paginator 117 comprises a translator that receives a file in a first book format, e.g., .epub, from converter 109. These files are in a format that typically do not include pagination. Paginator 117 is capable of indicating page transitions for content of files from translator 117, even in the case that files from translator 117 lack any page information.

The epub or input XML files are predominantly defined by a markup vocabulary for a specific application domain. Thus, these files have no default formatting styles, as is the case with HTML. Instead, style sheets are typically used to associate presentational information with XML documents.

The W3C has developed a stylesheet language specifically for XML known as the eXtensible Stylesheet Language (XSL). XSL consists of a transformation language (XSLT) and a language for high-quality formatting and layout of XML documents known as XSL Formatting Objects (XSL-FO). The XSLT Specification has been a W3C Recommendation since 1999 and provides a means of transforming content from XML to other formats (including, but not limited to, XML). XSLT processors are available in various programming languages. Recent versions of certain Web browsers also support XSLT processing.

### Book File 163

Book file 163 includes page transition indicators. Every one page comprises text between page transition indicators. Every page is equivalent to a page in a print copy of a book.

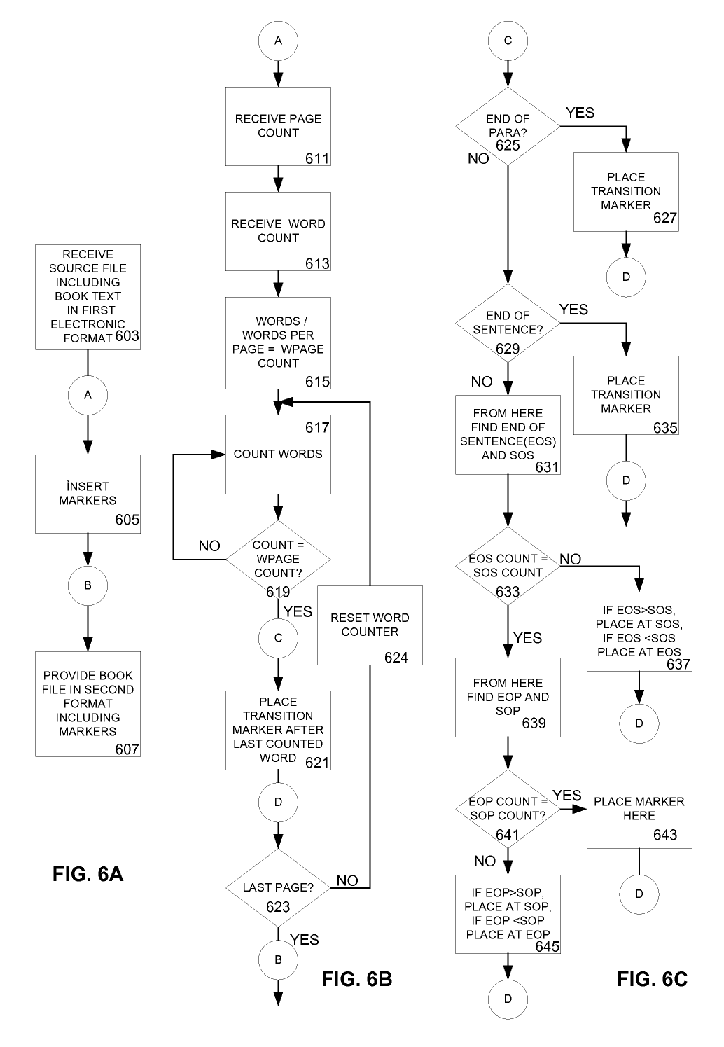

### FIGS. 6A-6C Server System Method

### FIG. 6A

FIGS. 6A-6C, illustrate methods for providing book file 163 according to various embodiments of the invention. According to a method illustrated FIG. 6A a content file including text is received at 603. The content file is formatted according to a first electronic format. The first electronic format represents the contents of a book as a non paginated text file. That is, first electronic format does not include information relating portions of the text file to pages of a printed version of the text.

At 605 page transition markers are inserted into the content file. In that manner the content file is converted from a first file format to a second file format. The second format includes information that relates portions of the text file to pages of a printed version of the text.

### FIG. 6B

FIG. 6B illustrates steps for carrying out the step of inserting markers (step 605 of FIG. 6A). At 611 a page count is received. The received page count is a count of the number of printed pages comprising a printed version of a book.

At 613 a word count is received. The word count is a count of the number of words in the content file corresponding to the printed version of a book. At 615 the word count is divided by the page count to determine a number of words per page (WPage count).

At 617 a word count of the text comprising the content file is initiated. In one example embodiment of the invention, words of the text are counted started with the first word of the first printed paragraph of the first chapter of the book. The word count proceeds until WPage count is reached, as indicated at 619. When Wpage count is reached a page transition marker is inserted in the file to be positioned after the last counted word (621). In that manner a first page is defined. At 624 the word counter is reset and the process repeats for succeeding words until the final page has been processed (623).

### FIG. 6C

FIG. 6C illustrates steps of a method for carrying out step 621 of FIG. 6B according to an embodiment of the invention. Step 625 is carried out after WPage count is reached. Step 625 determines if the last word counted for WPage count is the final word in a paragraph. If so, a transition marker is placed after the last counted word (627). Then, step 623 of the process of 6B is carried out.

If the last word counted for WPage count is not the final word in a paragraph, step 629 determines if the last counted word is the final word in a sentence (629). If the last counted word is the final word in a sentence, a transition marker is placed after the last counted word (635). Then, step 623 of the process of 6B is carried out.

If the last counted word is not the final word in a sentence, the number of words is counted from the last counted word to the end of the sentence (EOS) containing the last counted word (631). Also, the number of words is counted from the last counted word to the start of the sentence (SOS) containing the last counted word (631).

At 633 the EOS count is compared to the SOS count to determine if the number of words to the end of the sentence is equal to the number of words to the start of the sentence. If not, the position of the transition marker for that page is placed based on whether the last counted word is closer to the end of the sentence (EOS<SOS) or closer to the beginning of the sentence (EOS>SOS) (637). If the last counted word is closer to the end of the sentence than it is to the start of the sentence, a page transition marker is placed at the end of the sentence. (637)

If the EOS count is equal to the SOS count, the last counted word is considered to be in the middle of a sentence. In that case a number of words is counted between the last counted word and the end of the paragraph (EOP) containing the last counted word. Likewise, a number of words between the last counted word and the start of the paragraph (SOP) containing the last counted word is counted. (639) If the EOP count is equal to the SOP count a page transition marker is placed after the last counted word (643).

If the EOP count is not equal to the SOP count, placement of a transition marker is determined based on whether the last counted word is closer to the EOP or to the SOP. If the last counted word is closer to the SOP (EOP>SOP) a page transition marker is positioned at the SOP. If the last counted word is closer to the EOP (EOP<SOP) a transition marker is positioned at the EOP. The process continues at step 623 of FIG. 6B.

### Client System 155

### Hardware

FIG. 1 is a block diagram of book reader appliance 155. In one embodiment of the invention, book reader appliance 155 comprises a hand held media device such as the Apple iphone. Device 155 includes a processor 168 coupled to a first memory 163 and a second memory 165. The processor 168 is further coupled to a display driver (not shown) to drive display 157 and to a rendering engine 162 for operation of device 155 to present text from book files stored in memory 163 on display 157.

FIG. 3B illustrates an example hand held device 350 presenting text 355 on a display 353. Also displayed on display 353 is a page number (shown as page 1 in FIG. 3B). Because display 350 is smaller than page 303 (FIG. 3A) only a portion of the text corresponding to page 3A of book 300 is viewable on display 350 at any given time.

The invention enables processor 168 to select a portion of text stored in memory 163 defining a page of book 300 to be stored in page buffer 165. Rendering engine 162 defines a first viewport 184 for containing portions of text stored in page buffer 165 for display on display 157.

Rendering engine 162 further defines a second viewport 159 for displaying a page number on display 159.

According to one embodiment of the invention, display 350 is a touch screen display device. In that embodiment, device 350 is responsive to movement of a viewer's fingers across the display screen in a vertical direction 380. Movement in vertical direction 380 results in processor

The computing device 100 may include one or more expansion slots. In an embodiment shown, a first peripheral port 102 enables one or more types of accessory devices to be connected to processor 140. In addition, computing device 100 may include a wireless peripheral port 104 that enables information to be communicated to processor 140 from an external source. The wireless peripheral port 104 forwards incoming communications to an amplifier 106 for processor 140. A second processor 108 intercepts communications incoming to and/or outgoing from wireless peripheral port 104 for purpose of facilitating conversion of data signals between formats and protocols of wireless communications, and those that can be processed by processor 140.

Touch screen 158 (FIG. 1) of display 157 detects a deflection entered as input by a user by the user dragging the user's finger across the screen. The deflection input may be measured as a value that is signaled to processor 168. The deflection input in a vertical direction causes portions of a pages stored in page buffer 165 to be displayed on display 157. Deflection in a horizontal direction causes a new page to be loaded into page buffer 165.

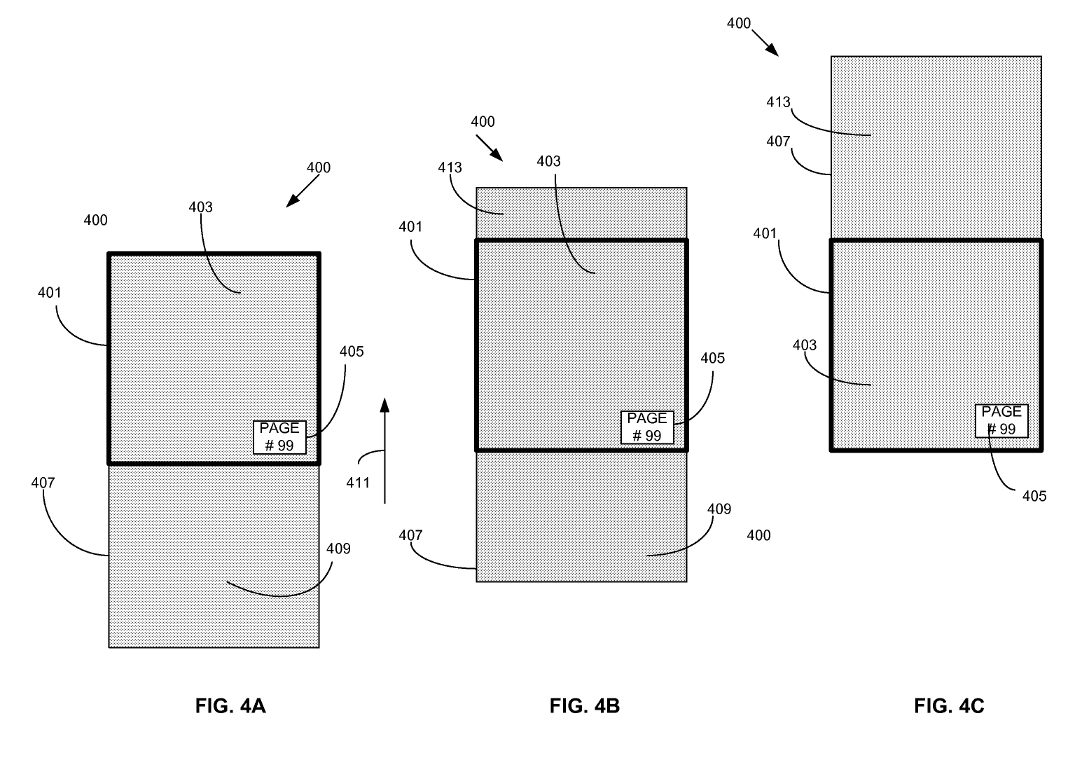

In that manner a user can scroll by touching the display in a vertical direction to view different portions of the same page. This is illustrated in FIGS. 4A to 4C wherein a first viewport is indicated at 410 and a second viewport for displaying a page number is indicated at 405. A page 407 is stored in page buffer 165 (FIG. 1). The user can also select to view other portions of the same page by scrolling (vertical movement 521).

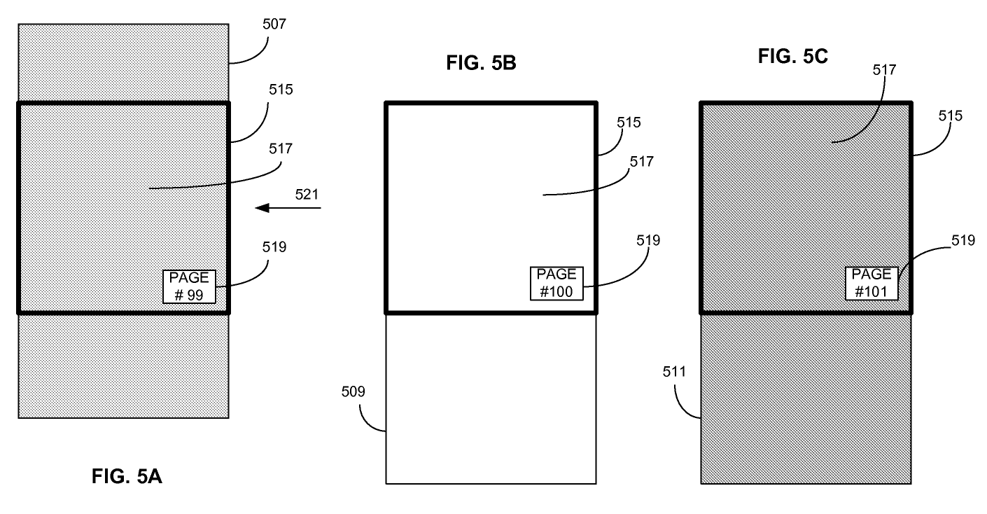

The user can also select to view other pages by flicking (horizontal movement 521). This feature is illustrated in FIGS. 5A to 5B wherein a viewport is indicated at 515, a first page is 507, second page is 509, third page is 511. Alternatively, to make selections for other pages, a user can select a user-interactive feature, such as an icon on the display, or a mechanical button. The page that appears after the user's selection coincides with a page stored as the next or adjacent page to the existing page appearing on the display.

While the invention has been shown and described with respect to particular embodiments, it is not thus limited. Numerous modifications, changes and enhancements will now be apparent to the reader.

What is claimed is:

1. An electronic book file converter system comprising
an input for receiving an electronic file in a first format, the file including a text portion representing text of a printed book version;
a page transition detector for detecting page transitions in said printed book version;
a page transition marker configured to insert a page transition indicator in said first format file at each detected page transition,
said converter system thereby converting said first format file to a second format file, the second file format enabling pagination of said electronic book in accordance with page numbers of said printed version.

2. The system of claim 1 further comprising an output for providing the second format electronic file to a book reading device for presentation to a viewer.

3. A method for converting an electronic book file in a first format not including page indications to an electronic book file in a second format including page indications comprising:
receiving an electronic book file in said first format;
determining page transitions locations in said first format file;
inserting page transition indicators into said first format file in accordance with the determined page transitions;
thereby providing an electronic book file in a second format, the second file format including page indications.

4. A system for presenting an electronic book to a viewer comprising:
a display device including first viewing area and a second viewing area, the display device including a touch sensitive area;
an electronic file comprising contents of the book, the electronic file including page transition markers, the page transition markers defining pages corresponding to pages of a print version of the book;
a buffer storing data representing a first page to be displayed on said display device;
a rendering engine for rendering at least portions of said first page on said first viewing area;
a processor coupled to said display device to receive horizontal and vertical touch indications from said viewer, and coupled to said rendering engine;
said rendering engine rendering portions of said first page on said first viewing area in accordance with first direction touch indications from said viewer;
said processor causing said rendering engine to replace said data representing said first page with data representing a second page in responsive to receiving second touch indications from said viewer.
